(19) United States
(12) Patent Application Publication
(10) Pub. No.: US 2009/0186226 A1
(43) Pub. Date: Jul. 23, 2009

(54) MESOSTRUCTURED ORGANIC-INORGANIC HYBRID MATERIAL

(76) Inventors: Alexandra Chaumonnoi, Lyon (FR); Clement Sanchez, Gif-Sur-Yvette (FR); Cedric Boissiere, Paris (FR); David Grosso, Rueil Malmaison (FR); Stephanie Pega, Aulnay Sous Bois (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/096,379

(22) PCT Filed: Nov. 3, 2006
(86) PCT No.: PCT/FR2006/002467

§ 371 Date: Mar. 30, 2009

(30) Foreign Application Priority Data
Dec. 9, 2005 (FR) 0512658

(51) Int. Cl. B32B 5/16; B29B 9/12

(52) U.S. Cl. 428/402; 264/12

(57) ABSTRACT

An organic/inorganic hybrid material (OIHM) that consists of elementary spherical particles is described, whereby each of said spherical particles consists of a mesostructured matrix that is based on silicon oxide and organic groups with reactive terminal groups that are linked covalently to the inorganic structure, whereby said mesostructured matrix has a pore size of between 1.5 and 30 nm and has amorphous walls with a thickness of between 1 and 20 nm. Said elementary spherical particles have a maximum diameter of 10 μm. The matrix that is based on silicon oxide can contain aluminum, titanium, zirconium and cerium. Two methods for preparation of said material are also described.

### TECHNICAL FIELD OF THE INVENTION

This invention relates to the field of organic-inorganic hybrid materials comprising silicon, in particular hybrid materials of which the inorganic matrix is in the form of metallic oxides that contain silicon and have a porosity that is organized and uniform on the scale of mesopores. It also relates to the preparation of these materials that are obtained by using the so-called “aerosol” synthesis technique.

### EXAMINATION OF THE PRIOR ART

The materials with a porosity that is well defined in a very wide range, ranging from microporous materials to macroporous materials by passing through materials with hierarchized porosity, i.e., having a mesoporous structure that is defined on several scales (from the angstrom to the millimeter), have known a very broad development within the scientific community since the mid-1990s (G. J. of A. A. Soler-Illia, C. Sanchez, B. Lebeau, J. Patarin, Chem. Rev., 2002, 102, 4093).

It is known to obtain materials whose pore size is well-controlled. In particular, the development of so-called “soft chemistry” synthesis methods has led to the production of mesostructured materials at low temperature. The soft chemistry methods consist essentially in bringing inorganic precursors, in an aqueous solution or in polar solvents, into the presence of a structuring agent, generally a molecular or supramolecular surfactant that is ionic or neutral.

Controlling the electrostatic interactions or the interactions by hydrogen bonds between the inorganic precursors and the structuring agent, jointly linked to hydrolysis/condensation reactions of the inorganic precursor, leads to a cooperative assembly of organic and inorganic phases generating micellar aggregates of surfactants that are of uniform size and are controlled within an inorganic matrix.

The disclosure of the porosity is then obtained by elimination of the surfactant, the latter being produced conventionally by processes of chemical extraction or by heat treatment.

Based on the nature of the inorganic precursors and the structuring agent that is used as well as the operating conditions that are imposed, several families of mesostructured materials have been developed.

For example, the M41S family initially developed by Mobil (J. S. Beck, J. C. Vartuli, W. J. Roth, M. E. Leonowicz, C. T. Kresge, K. D. Schmitt, C. T.-W. Chu, D. H. Olson, E. W. Sheppard, S. B. McCullen, J. B. Higgins, J. L. Schlenker, J. Am. Chem. Soc., 1992, 114, 27, 10834) consists of mesoporous materials that are obtained by means of the use of ionic surfactants such as quaternary ammonium salts, having a generally hexagonal, cubic or lamellar structure, pores of a uniform size within a range from 1.5 to 10 nm, and amorphous walls with a thickness on the order of 1 to 2 nm (nm is the abbreviation of nanometer).

Below, structuring agents of a different chemical nature have been used as amphiphilic macromolecules of the block copolymer type, whereby the latter lead to mesostructured materials that have a generally hexagonal, cubic or lamellar structure, pores of a uniform size within a range of 4 to 50 nm, and amorphous walls with a thickness within a range of 3 to 7 nm (families of SBA, MSU, etc.).

The formation of a mesostructured inorganic network passes through a precise control of each of the individual stages of the synthesis. In particular, the chemical composition of the initial solution is a key parameter since the nature and the concentration of each of the reagents and solvents will act on the hydrolysis-condensation kinetics of the various inorganic precursors and will influence the nature and the force of the interactions brought into play between the organic and inorganic phases during the self-assembly process.

Another crucial stage of the synthesis is the destabilization of this initial solution that will initiate the joint phenomena of self-organization of the structuring agent and the hydrolysis-condensation of the inorganic precursors. This destabilization of the initial solution may be the result of chemical phenomena (precipitation, gelling) or physical phenomena (evaporation, temperature).

To date, the mesostructured solids most often studied have been obtained according to the methods of synthesis by precipitation (MCM, SBA, MSU). Generally, the synthesis of these materials that are obtained by precipitation requires a stage of curing in an autoclave, and all the reagents are not integrated with products in a stoichiometric amount since they can be found in the supernatant.

Based on the structure and the degree of organization desired for the final mesostructured material, these syntheses may have taken place in an acid medium (pH≦1) (WO 99/37705) or in a neutral medium (WO 96/39357), whereby the nature of the structuring agent that is used also plays a dominant role.

The elementary particles that are thus obtained do not have a uniform shape and are generally characterized by a size of more than 500 nm.

Less frequently, mesostructured materials can also be obtained by evaporation of solvents from dilute reagent solutions, whereby this process is usually referred to as “Self-Assembly Induced by Evaporation.” The principle consists in this case of a dilute reagent solution with a structuring agent concentration that is generally less than the critical micellar concentration (Cmc). The gradual evaporation of the solvents of the solution leads to a concentration of all the reagents until the structuring agent concentration reaches the Cmc and brings about the self-assembly of the “template” jointly with the formation of the mesostructured matrix. Compared with the method by precipitation, the method by evaporation has the advantage of allowing a better control of the hydrolysis-condensation of the reagents, of preserving the exact stoichiometry defined for the initial solution, and of obtaining the desired materials under various morphologies such as films, powders that consist of spherical particles, fibers, etc.

Among the techniques by evaporation, we will cite in particular the “dip-coating” technique (that it is possible to show by deposition by immersion), which leads to the formation of mesostructured films by deposition on a substrate (WO 99/15280; A. Brunet-Bruneau, A. Bourgeois, F. Cagnol, D. Grosso, C. Sanchez, J. Rivory, Thin Solid Films, 20004, 656, 455), as well as the aerosol technique that leads to the formation of perfectly spherical nanoparticles after atomization of the initial solution (C. J. Brinker, Y. Lu, A. Sellinger, H. Fan, Adv. Mater., 1999, 11, 7; S. Areva, C. Boissiere, D. Grosso, T. Asakawa, C. Sanchez, M. Linden, Chem. Com., 2004, 1630).

It should be noted that obtaining a mesostructured matrix is in general promoted during the “dip-coating” technique owing to the presence of the substrate as an anchoring point in the formation of the material relative to the aerosol technique at the end of which a powder is obtained directly.

The extrapolation of a synthesis method by “dip-coating” to an aerosol method is therefore not direct. The aerosol process offers the advantage of allowing the synthesis of materials in an economical and continuous way in the form of powders that can be used in the industry as is or after shaping.

It should be noted that once their porosity is disclosed by the elimination of the structuring agent, the materials that are described above consist of a purely inorganic matrix, unlike materials according to this invention that have a hybrid matrix in the sense that the structure or inorganic framework of the matrix is supplemented by organic groups, as will be explained later.

Within the framework of the development of new materials, obtaining organic-inorganic hybrid materials (OIHM) that combine the properties of each of the two phases is of very great advantage (P. Gomez Romero, C. Sanchez (eds), “Functional Hybrid Materials,” WILEY-VCH, 2004; C. Sanchez, B. Jullian, P. Belleville, M. Popall, J. Mater. Chem., 2005, 15 (35-36), 3559).

To date, several synthesis methods lead to the formation of these hybrid materials. In the particular case of interactions of a covalent nature between the organic part and the inorganic part, two synthesis methods are usually encountered:
The direct synthesis that consists in incorporating the organic group directly during the sol-gel synthesis of an inorganic solid by using a metallic organo-alkoxide precursor, and
The synthesis by post-treatment that consists in obtaining, in a first step, an inorganic solid and in functionalizing the surface, during a second step, by reaction of a metallic organoalkoxide with the surface hydroxyl groups.

The first method that is cited offers the advantage of allowing the incorporation of large contents of organic fragments compared to the post-treatment technique that is limited by the surface condition of the initially-formed solid. In exchange, the organic part being incorporated at the same time that the development of the inorganic framework is done, the accessibility of the organic sites is not complete.

The production of mesostructured OIHM by use of a suitable metallic organoalkoxide precursor leads to the formation of a hybrid mesostructured network in which the organic fragments come to be positioned at the walls of the mesopores.

Placing the organic part on the surface of the mesopores associated with the mesostructure of the framework promotes the accessibility to the organic sites.

The first mesostructured OIHM were obtained in 1996 via the precipitation technique (S. L. Burket, S. D. Sims, S. Mann, Chem. Comm., 1996, 1367).

More recently, organic-inorganic hybrid films were obtained by “dip-coating,” whereby the matrix is essentially silicic and the incorporated organic fragments are of a variable nature: carbon-containing alkyl chains, fluorinated alkyl chains, alkyl chains that carry thiol, amine, dinitrophenyl, etc., terminal reactive groups (U.S. Pat. No. 6,387,453, 2002).

Rare examples deal with the processing of OIHM by the aerosol method.

A first example deals with the incorporation in the framework itself of the silicic inorganic mesostructured matrix of an organic fragment by using a particular precursor (OR)₃Si—R′—Si(OR)₃ with R′=—(CH₂)ₙ—, phenyl, vinyl. In this particular case, the organic fragment is an integral part of the framework and is therefore not “hanging” in the mesopores (U.S. Pat. No. 0,046,682, 2002).

A second example deals with a mesostructured OIHM that is obtained with the use of the organoalkoxysilane precursor (OEt)₃Si—CH₃, whereby the corresponding solid is characterized by the presence of methyl groups located on the walls of the pores of the mesostructure.

Obtaining the mesostructured OIHM by the aerosol method characterized by organic fragments that carry accessible reactive terminal groups (properties of acid-basicity, adsorption, etc.), outside of the simple alkyl chains, has never been reported, to our knowledge. This is probably explained by the difficulty of controlling the interactions between the various reagents at the origin of the mesostructure during the aerosol process in the presence of reactive groups of the thiol, amine, acid, basic type, etc.

### SUMMARY DESCRIPTION OF THE FIGURES

FIGS. 1, 2, and 3 illustrate the solid that is described in Example 1.

FIGS. 4, 5, 6 and 7 illustrate the solid that is described in Example 3.

### SUMMARY PRESENTATION OF THE INVENTION

The invention relates to an organic-inorganic hybrid material (denoted OIHM below) that consists of essentially spherical elementary particles, whereby each spherical particle consists of a mesostructured matrix that is based on silicon oxide and organic groups with reactive terminal groups that are linked covalently to the inorganic framework of the matrix, whereby said mesostructured matrix has a pore size of between 1.5 and 30 nm and has amorphous walls with a thickness of between 1 and 20 nm.

The elementary spherical particles have a maximum diameter of 10 μm.

The matrix that is based on silicon oxide optionally can also comprise at least one element Z that is selected from the group that consists of aluminum, titanium, tungsten, zirconium and cerium.

The organic groups, linked covalently to the mesostructured matrix, are carriers of at least one reactive terminal group that has acid-basic properties, or nucleophilic properties, or adsorption properties, preferably selected according to the function in the groups below:
For the acid reactive functions, the group consists of sulfonic acid —SO₃H, carboxylic acid —COOH, and derivative, OH, phosphonic acid,
For the basic reactive functions, the group consists of primary, secondary or tertiary amines, and OH,
For the nucleophilic reactive functions, the group consists of halides and preferably chlorine, OH, and
For the adsorbent reactive functions, the group consists of thiol groups for the collection of mercuric derivatives, whereby the latter can also exist in their disulfide oxidized form.

Preferably, the terminal reactive groups in question are the groups —SO₃H, —SH, —NH₂, and also preferably the group —SO₃H.

A mesostructured matrix that comprises organic groups with reactive terminal groups that belong to other groups is perfectly within the scope of the invention.

This invention also relates to a method for preparation of the mesostructured OIHM.

A first process for preparation of the material according to the invention comprises:
a) The mixing in solution of at least one surfactant, at least one silicic precursor, optionally at least one precursor of at least one element Z that is selected from the group that consist of aluminum, titanium, tungsten, zirconium and cerium, and at least one organosilane precursor that has at least one terminal reactive group, whereby said terminal reactive group that is selected is the one that is desired for the final material,
b) The atomization by aerosol of said solution that is obtained in stage a) to lead to the formation of spherical droplets with a diameter of less than 200 μm,
c) The drying of said droplets, and
d) The elimination of said surfactant for obtaining an OIHM with organized and uniform porosity.

A second process for preparation of the material according to the invention comprises:
a′) The mixing in solution of at least one surfactant, at least one silicic precursor, optionally at least one precursor of at least one element Z that is selected from the group that consists of aluminum, titanium, tungsten, zirconium and cerium, and at least one organosilane precursor that has at least one intermediate organic group with an organic group that has the terminal reactive group that is desired for the final material,
b′) The atomization by aerosol of said solution that is obtained in stage a′) for leading to the formation of spherical droplets with a diameter of less than 200 μm,
c′) The drying of said droplets,
d′) The elimination of said surfactant for obtaining a material with organized and uniform porosity, and
e′) The transformation of the intermediate organic group of the hybrid material that is obtained in stage d′) into the organic group that has the terminal reactive group that is desired by suitable chemical treatments.

The ordered structure of the matrix of the OIHM according to the invention is the result of the phenomenon of micellization or self-assembly by evaporation caused by the so-called aerosol technique.

The organic-inorganic hybrid material (OIHM) according to the invention simultaneously has the structural, textural, acid-basicity and/or adsorption properties that are suitable to mesostructured inorganic materials that are based on silicon, and the acid-basicity, nucleophilia and/or adsorption properties that are inherent in functionalized organic groups.

In addition, the mesostructured OIHM according to the invention consists of spherical elementary particles, whereby the diameter of these particles advantageously varies from 50 nm to 10 μm and preferably from 50 to 300 nm.

The reduced size of these particles as well as their homogeneous shape makes it possible to benefit from a better diffusion of the reagents and products of the reaction during the use of the mesostructured OIHM according to the invention in industrial applications, compared to known OIHM of the prior art that come in the form of elementary particles of non-homogeneous shape, i.e., irregular, and with a size of much more than 500 nm.

It is actually well known to one skilled in the art that the problems of diffusional limitation are reduced when the size of the particles that are bought into play becomes smaller.

In contrast, the process for preparation of the material according to the invention makes it possible to easily develop mesostructured OIHM, whereby the ordered structure of the material is the result of the phenomenon of micellization or self-assembly by evaporation caused by the so-called aerosol technique.

Furthermore, via a single-stage synthesis method, the incorporation of the organic precursor within the initial solution makes it possible to develop hybrid materials that have organic groups that are located in a preferred way on the walls of the pores of the mesostructured matrix that constitutes the elementary spherical particles of the OIHM according to the invention.

Finally, relative to the known syntheses of the mesostructured materials, the production of the material according to the invention is carried out continuously. The preparation period is reduced to several hours from 12 to 24 hours by using autoclaving, and the stoichiometry of the non-volatile radicals that are present in the initial solution of the reagents is maintained in the material of the invention.

### DETAILED DISCLOSURE OF THE INVENTION

This invention has as its object an organic-inorganic hybrid material (denoted OIHM in the text below) that consists of elementary spherical particles, whereby each of the elementary spherical particles consists of a mesostructured matrix that is based on silicon oxide, and organic groups with reactive terminal groups that are linked covalently to the inorganic structure of the matrix.

Mesostructured matrix is defined in terms of this invention as a matrix that has an organized porosity on the scale of the mesopores, whereby said mesopores have a uniform size of between 1.5 and 30 nm, and preferably between 1.5 and 10 nm, and are distributed homogeneously and uniformly in each of the particles that constitute the material according to the invention.

It should be noted that a porosity of microporous nature can also result from the overlapping of the surfactant, used during the preparation of the material according to the invention, with the inorganic wall at the organic-inorganic interface that is developed during the mesostructuring of the inorganic component of said material according to the invention.

The material that is located between the mesopores of each spherical particle is amorphous and forms walls whose thickness is between 1 and 20 nm. The thickness of the walls corresponds to the average distance that separates one pore from another pore. The organization of the mesoporosity that is described above leads to a structuring of the matrix that may be hexagonal, cubic, cholesteric, lamellar, bicontinuous or vermicular.

Reactive terminal group is defined as any organic group that has acid-basic or nucleophilic or adsorption properties. For example, in a non-exhaustive way, we will cite in particular:
For the acid reactive groups: sulfonic acid —SO₃H, carboxylic acid —COOH and derivative, the OH group, phosphonic acid,
For the basic reactive groups: the primary, secondary, and tertiary amines, OH,
For the nucleophilic reactive groups: the halides, and, preferably, chlorine,
For the adsorbent reactive groups: the thiol groups for the collection of mercuric derivatives, whereby the latter can also exist in their disulfide oxidized form.

Preferably, the terminal reactive groups are the groups —SO₃H, —SH, —NH₂ and more preferably the group —SO₃H.

According to a particular type of hybrid material according to the invention, the matrix that is based on silicon oxide has an entirely silicic inorganic part.

According to another particular type of hybrid material according to the invention, the matrix that is based on silicon oxide also comprises, in its inorganic part, at least one element Z that is selected from the group that consists of aluminum, titanium, tungsten, zirconium and cerium.

According to a particular type of hybrid material according to the invention, the organic groups of the mesostructured matrix, and in particular the reactive terminal groups, are identical and obtained from using a single organosilane precursor.

According to another particular type of hybrid material according to the invention, the organic groups of the mesostructured matrix, and in particular the reactive terminal groups, can be different and can be obtained from using at least two organosilane precursors, with the proviso that the various terminal reactive groups being considered are compatible with the process, i.e., that they do not react with one another and do not cause the precipitation of the precursors in the initial solution.

According to the invention, the organic groups advantageously represent 0.1 to 50 mol %, and preferably 0.1 to 30 mol % of the inorganic matrix based on the mesostructured OIHM silicon oxide according to the invention.

According to the invention, the elementary spherical particles that constitute the material according to the invention have a diameter that is advantageously encompassed between 50 nm and 10 μm, preferably between 50 and 300 nm. More specifically, they are present in the material according to the invention in the form of aggregates.

The material according to the invention advantageously offers a specific surface area of between 100 and 1500 m²/g, and very advantageously between 300 and 1000 m²/g.

This invention also has as its object the preparation of the material according to the invention. The first preparation process according to the invention comprises:
a) The mixing in solution of at least one surfactant, at least one silicic precursor, optionally at least one precursor of at least one element Z that is selected from the group that consists of aluminum, titanium, tungsten, zirconium and cerium, and at least one organosilane precursor that has at least one terminal reactive group, whereby said selected terminal reactive group is the one that is desired for the final material;
b) The atomization by aerosol of said solution that is obtained in stage a) to lead to the formation of spherical droplets with a diameter of less than 200 μm;
c) The drying of said droplets, and
d) The elimination of said surfactant for obtaining an OHM with organized and uniform porosity.

According to stage a) of the first process for preparation according to the invention, the silicic precursor and optionally the precursor of at least one element Z are inorganic oxide precursors that are well known to one skilled in the art.

The silicic precursor is obtained from an organometallic precursor of formula Si(OR)₄, where R═H, methyl, ethyl.

The precursor of the element Z can be any organometallic compound that comprises the element Z of formula Z(OR)ₙ with, for example, R=methyl, ethyl, isopropyl, n-butyl, s-butyl or t-butyl, etc. The precursor of element Z can also be an oxide, a metallic hydroxide or a metallic chloride of formula Z(Cl)ₙ.

Said organic groups are introduced within the material according to the invention by using organosilane precursors according to stage a) of the first process for preparation according to the invention. Any organoalkoxysilane or organochlorosilane that has one or more terminal reactive groups can be used. In particular, an organoalkoxysilane of dendritic nature can be used, whereby the latter is a monodisperse hypberbranched polymer of nanoscopic size that consists of a generally alkoxysilane reactive core and that has a large number of reactive terminal groups on its periphery.

The organoalkoxysilane and organochlorosilane precursors are preferably respectively characterized by the following general formulas: (OR)₄₋ₓSi—(R′—F)ₓ and (Cl)₄₋ₓSi—(R′—F)ₓ (x=1 or 2) with R═H, methyl, ethyl, R′=alkyl, phenylalkyl, and arylalkyl chains, whereby F is a terminal reactive group.

The alkoxysilane fragment —Si(OR′)₄₋ₓ (x=1 or 2) or chlorosilane fragment —Si(Cl)₄₋ₓ (x=1 or 2) of the possible precursor makes it possible, via hydrolysis-condensation reactions, to incorporate the organic group(s) —R—F in the inorganic framework via the covalent bond of the silicon with the fragment(s) —R— of the organic group (generally an Si—C bond).

The fragment(s) —R— of the organic group can be considered as a spacer between the inorganic framework and the terminal reactive group in question.

The reactive terminal group F is selected from the group of functions that consists of: the acidic reactive groups such as sulfonic acid —SO₃H, carboxylic acid —COOH, and derivative, OH, phosphonic acid, the basic reactive groups such as the amines (primary, secondary, and tertiary), OH, the nucleophilic reactive groups such as halide (preferably, the halogen is chlorine), OH, and the adsorbent reactive groups such as the thiol groups for the collection of mercuric derivatives, whereby the latter can also exist in their disulfide oxidized form.

Preferably, the terminal reactive groups in question are the groups —SO₃H, —SH, —NH₂, and, more preferably, the group —SO₃H.

In the case where the desired terminal reactive group F is a thiol group, a usable organoalkoxysilane precursor is in particular the trimethoxymercaptopropylsilane precursor (OMe)₃Si—(CH₂)₃—SH.

In the case where the desired terminal reactive group F is a primary amine group, a usable organoalkoxysilane precursor is in particular the aminopropyltriethoxysilane precursor (OEt)₃Si—(CH₂)₃—NH₂.

In the preferred case where the desired reactive terminal group F is a sulfonic acid group, a usable organoalkoxysilane precursor is in particular the (chlorosulfonylphenyl-ethyl acid)trimethoxysilane precursor (OMe)₃Si—(CH₂)₂—C₆H₄—SO₂Cland a usable organochlorosilane precursor is in particular the (chlorosulfonyphenyl ethyl acid)trichlorosilane precursor (Cl)₃Si—(CH₂)₂—C₆H₄—SO₂Cl.

The surfactant that is used for the preparation of the mixture according to stage a) of the first process for preparation of the mesostructured OIHM according to the invention is an ionic or nonionic surfactant or a mixture of the two.

Preferably, the ionic surfactant is selected from among the phosphonium and ammonium ions and very preferably from among the quaternary ammonium salts such as cetyltrimethylammonium bromide (CTAB).

Preferably, the nonionic surfactant comes in the form of a copolymer that has at least two parts of different polarity that imparts to it amphiphilic macromolecule properties. It can be in particular a copolymer that is selected from the nonexhaustive list of the following copolymer families: the fluorinated copolymers (—[CH₂—CH₂—CH₂—CH₂—O—CO—R1]— with R1=C₄F₉, C₈F₁₇, etc.), the biological copolymers such as the amino polyacids (poly-lysine, alginates, etc.), the dendrimers, the block copolymers that consist of poly(alkylene oxide) chains and any other copolymer with an amphiphilic nature that is known to one skilled in the art (S. Forster, M. Antionnetti, Adv. Mater, 1998, 10, 195-217; S. Förster, T. Plantenberg, Angew. Chem. Int. Ed, 2002, 41, 688-714; H. Cölfen, Macromol. Rapid Commun, 2001, 22, 219-252).

Preferably, within the scope of this invention, a copolymer that is selected from among the family of block copolymers that consist of poly(alkylene oxide) chains is used. Said block copolymer is preferably a block copolymer that has two, three or four blocks, whereby each block consists of a poly(alkylene oxide) chain.

For a copolymer with two blocks, one of the blocks consists of a poly(alkylene oxide) chain of a hydrophilic nature, and the other block consists of a poly(alkylene oxide) chain of a hydrophobic nature.

For a copolymer with three blocks, two of the blocks consist of a poly(alkylene oxide) chain of a hydrophilic nature while the other block, located between the two blocks with hydrophilic parts, consists of a poly(alkylene oxide) chain of a hydrophobic nature.

Preferably, in the case of a copolymer with three blocks, the poly(alkylene oxide) chains of a hydrophilic nature are poly(ethylene oxide) chains that are denoted (PEO)ₓ and (PEO)_{z}, and the poly(alkylene oxide) chains of a hydrophobic nature are poly(propylene oxide) chains that are denoted (PPO)_{y}, poly(butylene oxide) chains or mixed chains of which each chain is a mixture of several alkylene oxide monomers.

Very preferably, in the case of a copolymer with three blocks, a compound of formula (PEO)ₓ—(P PO)_{y}—(PEO)_{z}, where x is between 5 and 300, y is between 33 and 300, and z is between 5 and 300, is used.

Preferably, the values of x and z are identical. Very advantageously, a compound in which x=20, y=70, and z=20 (poly(ethylene oxide)₂₀-poly(propylene oxide)₇₀-poly(ethylene oxide)₂₀ or else called P123), and a compound in which x=106, y=70, and z=106 (F127) are used.

The commercial nonionic surfactants that are known under the name of Pluronic (BASF), Tetronic (BASF), Triton (Sigma), Tergitol (Union Carbide), Brij (Aldrich) can be used as nonionic surfactants in stage a) of the first process for preparation of the mesostructured OIHM according to the invention.

For a copolymer with four blocks, two of the blocks consist of a poly(alkylene oxide) chain of a hydrophilic nature, and the other two blocks consist of a poly(alkylene oxide) chain of a hydrophobic nature.

The stage for atomization of the mixture according to stage b) of the first process for preparation of the mesostructured OIHM according to the invention produces spherical droplets with a diameter that is less than or equal to 200 μm, and preferably in a range of between 50 nm and 20 μm.

The size distribution of these droplets is lognormal. The aerosol generator that is used here is a model 9306 commercial device provided by TSI that has a 6-jet atomizer. The atomization of the solution is done in a chamber into which a vector gas, an O₂/N₂ (dry air) mixture, is sent under a pressure P that is equal to about 1 bar (1 bar=10 5 pascals).

According to stage c) of the first process for preparation according to the invention, drying of said droplets is initiated. This drying is carried out by the transport of said droplets via the vector gas, the O₂/N₂ mixture, in glass tubes, which leads to the gradual evaporation of the solution, for example of the acidic aquo-organic solution as specified in this disclosure below and thus to obtaining spherical elementary particles.

This drying is also improved by running said particles through a furnace whose temperature can be adjusted, whereby the usual temperature range varies from 50° C. to 600° C., and preferably from 80° C. to 400° C.

The dwell time of the particles in the furnace is on the order of one second.

The particles are then recovered in a filter and constitute the mesostructured material according to the invention. A pump that is placed at the circuit's end helps channel the radicals into the experimental aerosol device.

The drying of the droplets according to stage c) of the first process for preparation according to the invention is advantageously followed by running them through the oven at a temperature of between 50 and 150° C.

The elimination of the surfactant during stage d) of the first process for preparation according to the invention is advantageously carried out by chemical extraction processes or via suitable heat treatments so as to decompose selectively the organic surfactant without modifying the organic groups of the mesostructured OIHM according to the invention.

Preferably, the surfactant is eliminated by reflux washing in an organic solvent such as ethanol.

A possible variant to the first process for preparation according to the invention consists in deferring by 2 hours respectively the addition of at least one organosilane precursor that has at least one terminal reactive group, whereby said terminal group that is selected is the one that is desired for the final material relative to other reagents during stage a) of the first process for preparation according to the invention.

In a second embodiment of the process for preparation of the mesostructured OIHM according to the invention that is called “second process for preparation according to the invention” below, the organic precursors that are introduced into the initial solution of the reagents have intermediate organic groups, and the terminal reactive groups that are desired will be obtained only after a chemical treatment of these intermediate groups.

More concretely, this second process for preparation according to the invention comprises:
a′) The mixing in solution of at least one surfactant, at least one silicic precursor, optionally at least one precursor of at least one element Z that is selected from the group that consists of aluminum, titanium, tungsten, zirconium and cerium, and at least one organosilane precursor that has at least one intermediate organic group,
b′) The atomization by aerosol of said solution that is obtained in stage a′) to result in the formation of spherical droplets with a diameter of less than 200 μm,
c′) The drying of said droplets,
d′) The elimination of said surfactant for obtaining a material with organized and uniform porosity, and
e′) The transformation of the intermediate organic group of the hybrid material that is obtained in stage d′) into the organic group that has the terminal reactive group that is desired by suitable chemical treatments.

According to stage a′) of the second process for preparation according to the invention, the silicic precursor, optionally the precursor of at least one element Z, and the surfactant that is used for the preparation of the mixture of stage a′) are identical to those that are defined during stage a) of the first process for preparation according to the invention.

Said intermediate organic groups are introduced into the solution of stage a′) of the second process for preparation according to the invention via the use of organosilane precursors as described in stage a) of the first process for preparation according to the invention.

Said intermediate organic groups are carefully selected so as to lead to—after chemical treatments—the formation of organic groups —R—F where F is the desired terminal reactive group.

Preferably, the reactive terminal groups in question are the groups —SO₃H, —SH, —NH₂ and also preferably the group —SO₃H.

For example, when the desired terminal reactive group F is a sulfonic acid group, the intermediate organic group may have a thiol group or be a phenylalkyl chain that can respectively undergo an oxidation stage or a sulfonation stage to lead to the desired —SO₃H group.

The stages b′), c′), and d′) of the second process for preparation according to the invention are in all respects similar to stages b), c), and d) of the first process for preparation according to the invention.

The chemical treatments that lead to the transformation of the intermediate organic group into the organic group that has the desired terminal reactive group according to stage e′) are selected so as not to damage the mesostructuring of the hybrid material that is obtained in stage d′) and to preserve as well as possible the content of organic groups that are introduced into the initial solution of stage a′).

In the particular preferred case where the desired terminal reactive group is the sulfonic acid group, an intermediate organic product that has a thiol group can be oxidized according to the standard procedures that are known to one skilled in the art, such as treatments with hydrogen peroxide, nitric acid, barium permanganate, etc.

After oxidation, the material that is obtained is washed with water and dried by oven drying at a temperature of between 50° C. and 150° C.

During the use of a phenylalkyl organic intermediate group, the sulfonation of the aromatic cycle is carried out according to the known standard methods of one skilled in the art: treatments with chlorosulfonic acid, with concentrated sulfuric acid, with sulfur oxide SO₃, etc.

A first possible variant to the second process for preparation according to the invention consists in carrying out stage e′) simultaneously to stage a′).

A second possible variant to the second process for preparation according to the invention consists in deferring by 2 hours the addition of an organosilane precursor that has at least one intermediate organic group to an organic group that has the desired terminal reactive group during stage a′) of the second process for preparation according to the invention.

The solution in which all of the reagents are mixed according to stages a) and a′) respectively of the first and second process for preparation according to the invention can be acidic, neutral or basic.

Preferably, said solution is acidic and has a maximum pH that is equal to 3, preferably between 0 and 2.

The acids that are used to obtain an acid solution with a maximum pH that is equal to 3 are, in a non-exhaustive manner, hydrochloric acid, sulfuric acid and nitric acid. Said solution can be aqueous or can be a water-organic solvent mixture, whereby the organic solvent is preferably a water-miscible polar solvent, in particular THF or an alcohol, in this latter case preferably ethanol.

Said solution can also be virtually organic, preferably virtually alcoholic, whereby the amount of water is such that the hydrolysis of the inorganic and organosilane precursors is ensured in a stoichiometric manner.

Very preferably, said solution consists of acidic aquo-organic mixtures, and very preferably acid water-alcohol mixtures. This latter characteristic is valid for the two processes for preparation according to the invention.

The initial concentration of surfactant introduced into the mixture according to stages a) and a′) of the first and second processes for preparation according to the invention is defined by cₒ, and cₒ is defined relative to the critical micellar concentration (Cmc) that is well known to one skilled in the art.

The Cmc is the maximum concentration beyond which the self-assembly phenomenon of the molecules of the surfactant occurs in the solution. The concentration cₒ may be less than, equal to or greater than the Cmc; preferably it is less than the Cmc.

In a preferred implementation of each of the two processes for preparation according to the invention, the concentration cₒ is less than the Cmc, and said solution that is targeted in each of the stages a) and a′) of each of the two processes for preparation according to the invention is an acid water-alcohol mixture.

In the case where the solution that is targeted in each of stages a) and a′) of each of the two processes for preparation according to the invention is a water-organic solvent mixture, preferably acidic, it is preferred during each of said stages a) and a′) that the concentration in surfactant at the origin of the mesostructuring of the matrix be less than the critical micellar concentration, such that the evaporation of said preferably acidic aquo-organic solution, during each of stages b) and b′) by the aerosol technique, induces a phenomenon of micellization or self-assembly that leads to the mesostructuring of the matrix of the hybrid material of the invention.

When cₒ<Cmc, the mesostructuring of the matrix of the hybrid material according to the invention, prepared according to one of the two processes of the invention, follows a gradual concentration, within each droplet, surfactant, silicic precursor, organosilane precursor and optionally the precursor of at least one element Z, up to a concentration of surfactant c>Cmc that results from an evaporation of the preferably acidic aquo-organic solution.

In general, the increase of the combined concentration of the silicic precursor, the organosilane precursor, optionally the precursor of at least one element Z, and the surfactant causes the precipitation of the hydrolyzed silicic precursor, the hydrolyzed organosilane precursor, and optionally the hydrolyzed precursor of at least one element Z around the self-organized surfactant. The result is the structuring of the hybrid material according to the invention.

By a cooperative self-assembly mechanism, the inorganic/inorganic phase interactions, organic/organic phase interactions, and organic/inorganic phase interactions result in the condensation of the hydrolyzed silicic precursor, the hydrolyzed organosilane precursor, and optionally the hydrolyzed precursor of at least one element Z around the self-organized surfactant.

More specifically, relative to the behavior in solution of the organosilane precursor during self-assembly phenomena induced by evaporation, the hydrolysis-condensation reactions of the alkoxysilane or chlorosilane fragment will allow the adhesion of the organic group in the inorganic matrix by reaction with the hydrolyzed silicic precursor, and optionally the precursor that is hydrolyzed with at least one element Z, while the organic group, by affinity with the organic surfactant, will have a tendency to be located in the micellar phase that is defined by the surfactant.

This dual compatibility of the hydrolyzed organosilane precursor for the inorganic phase that is under construction, on the one hand, and for the organic phase combined with the surfactant, on the other hand, is at the origin of the preferred location of the organic groups and therefore of the terminal reactive groups that are present in the final material at the walls of the pores of the mesostructure.

The aerosol technique is particularly advantageous for the implementation of stages b) and b′) of each of the two processes according to the invention, so as to force the reagents that are present in the initial solution to interact with one another, whereby no loss of material besides the solvents is possible. All of the silicon elements, organic groups and optionally elements Z that are present initially are thus perfectly preserved throughout each of the two processes according to the invention while these reagents are partially eliminated during stages of filtration and washing cycles encountered in standard synthesis processes that are known to one skilled in the art.

The mesostructured OIHM of this invention can be obtained in the form of powder, balls, pellets, granules or extrudates, whereby the shaping operations are carried out by standard techniques that are known to one skilled in the art.

Preferably, the mesostructured OIHM according to the invention is obtained in the form of powder, which consists of elementary spherical particles that have a maximum diameter of 10 μm, which facilitates the possible diffusion of the reagents in the case of the use of the material according to the invention in a potential industrial application.

The mesostructured OIHM of the invention can be characterized by several analytical techniques and in particular by low-angle X-Ray Diffraction (low-angle XRD), by Nitrogen Volumetric Analysis (BET), by Transmission Electron Microscopy (TEM), and by HF-Induced Plasma Emission Spectrometry (ICP).

The presence of organic groups, and in particular terminal reactive groups, can be verified based on the chemical nature of the latter by additional analyses: ¹³C Nuclear Magnetic Resonance of the Solid (¹³C NMR-MAR), acid-basic metering.

The low-angle X-Ray Diffraction technique (values of angle 2θ of between 0.5° and 6°) makes it possible to characterize the periodicity on the nanometric scale generated by the organized mesoporicity of the mesostructured hybrid matrix of the material of the invention. The X-Ray Diffraction analysis is carried out on powder with a diffractometer that operates by reflection and is equipped with a rear monochromater by using copper radiation (wavelength of 1.5406 Å). The peaks that are usually observed on the diffractograms that correspond to a given value of the angle 2θ are combined with inter-reticular distances d₍ₕₖₗ₎ that are characteristic of the structural symmetry of the material, whereby (hkl) are the Miller indices of the reciprocal network, by Bragg's equation: 2 d₍ₕₖₗ₎*sin (θ)=η*λ. This indexing then allows the determination of mesh parameters (abc) of the direct network, whereby the value of these parameters is based on the hexagonal, cubic, cholesteric, lamellar, bicontinuous or vermicular structure that is obtained.

For example, the low-angle x-ray diffractogram of a mesostructured OIHM that consists of elementary spherical particles comprising a silicic matrix and organic groups with terminal reactive groups —R—F═—(CH₂)₂—C₆H₄—SO₃H that is obtained according to the first process for preparation according to the invention via the use of the cetyltrimethylammonium bromide quaternary ammonium salt CH₃(CH₂)₁₅N(CH₃)₃Br (CTAB) offers a perfectly resolved correlation peak that corresponds to the distance for correlation between pores d that is characteristic of a 2D hexagonal-type structure and that is defined by Bragg's equation 2 d₍ₕₖₗ₎*sin (θ)=η*λ.

The nitrogen volumetric analysis that corresponds to the physical adsorption of nitrogen molecules in the porosity of the material via a gradual increase of pressure at constant temperature gives information about the particular textural characteristics (pore diameter, type of porosity, specific surface area) of the mesostructured OIHM according to the invention. In particular, it makes it possible to access the specific surface area and the mesoporous distribution of the material.

Specific surface area is defined as the B.E.T. specific surface area (S_{BET} in m²/g) that is determined by nitrogen adsorption according to the ASTM D 3663-78 standard established from the BRUNAUER-EMMETT-TELLER method described in the periodical “The Journal of American Society,” 60, 309, (1938). The pore distribution that is representative of a mesopore population that is centered in a range of 1.5 to 50 nm is determined by the Barret-Joyner-Halenda (BJH) model. The nitrogen adsorption-desorption isotherm according to the thus obtained BJH model is described in the periodical “The Journal of American Society,” 73, 373 (1951) that was written by E. P. Barrett, L. G. Joyner and P. P. Halenda. In the following disclosure, the diameter of the mesopores φ of the given mesostructured hybrid matrix corresponds to the mean diameter with the nitrogen adsorption defined as being a diameter such that all the pores that are less than this diameter constitute 50% of the pore volume (Vp) that is measured on the adsorption branch of the nitrogen isotherm. In addition, the form of the nitrogen adsorption isotherm and the hysteresis loop can provide information on the nature of the mesoporosity and on the possible presence of microporosity in the mesostructured hybrid matrix.

For example, the nitrogen adsorption isotherm relative to a mesostructured OIHM that consists of elementary spherical particles comprising a silicic matrix and organic groups with terminal reactive groups —R—F═—(CH₂)₂—C₆H₄—SO₃H that is obtained according to the first process for preparation according to the invention via the use of the cetyltrimethylammonium bromide quaternary ammonium salt CH₃(CH₂)₁₅N(CH₃)₃Br (CTAB) is of class IVc with the presence of an adsorption progression for values of P/PO (where PO is the saturating vapor pressure at the temperature T) of between 0.2 and 0.3 associated with the presence of pores on the order of 1.5 to 3 nm as confirmed by the associated pore distribution curve.

Relative to the mesostructured OIHM, the difference between the value of the diameter of pores φ and the mesh parameter a defined by low-angle XRD as described above makes it possible to gain access to the value e where e=a−φ and is characteristic of the thickness of the amorphous walls of the mesostructured hybrid matrix that each constitute spherical particles of the material according to the invention.

Said mesh parameter a is connected to the distance d for correlation between pores by a geometric factor that is characteristic of the geometry of the phase. For example, in the case of a hexagonal mesh, e=a−φ with a 2*d/\sqrt{3}|, and in the case of a vermicular structure, e=d−φ.

The analysis by transmission electron microscopy (TEM) is a technique that is also widely used to characterize the structure of these materials. The latter allows an image of the solid that is being studied to be formed, whereby the contrasts that are observed are characteristic of the structural organization, the texture or else the morphology of the particles that are observed. The resolution of the technique reaches a maximum 0.2 nm. In the following disclosure, the TEM photos are made from microtomic fractions of the sample so as to display a section of an elementary spherical particle of the material according to the invention.

For example, the TEM images—that are obtained for a mesostructured OIHM that consists of elementary spherical particles comprising a silicic matrix and organic groups with terminal reactive groups —R—F═—(CH₂)₂—C₆H₄—SO₃H obtained according to the first process for preparation according to the invention via the use of the cetyltrimethylammonium bromide quaternary ammonium salt CH₃(CH₂)₁₅N(CH₃)₃Br (CTAB)—have spherical elementary particles that have a 2D hexagonal mesostructure, whereby the material is defined by the dark zones. The analysis of the image also makes it possible to gain access to the parameters d, φ and e that are characteristic of the mesostructured hybrid matrix defined above.

The analysis by ¹³C Nuclear Magnetic Resonance of the solid (¹³C NMR-MAR) is a technique of choice for characterizing the presence and the nature of organic groups that have terminal reactive groups of the material according to the invention. Actually, this technique makes it possible to know the environment that is close to a core being considered (short-distance order). It is based on the interaction of atomic cores that have a non-zero magnetic moment μ with an external magnetic field B_{O}.

By Zeeman effect, this interaction generates energy levels between which transitions can occur following the application of a radiofrequency-type wave. Each transition frequency corresponds to a core in a given chemical environment. Each core is therefore combined with a transition frequency, itself associated with a chemical shift that is expressed in terms of ppm. The various ¹³C NMR spectra of the solid have been recorded by means of BRUKER Avance 300 and Avance 400 high-resolution spectrometers. In the case of the study of solids, the anisotrophy of chemical shift and the existence of dipolar- or quadripolar-type interactions lead to a great expansion of the signals of spectra that are obtained. This expansion can be reduced by quick rotation of the sample along an axis that is inclined by an angle of θ=54° 44′ relative to the direction of the magnetic field B_{O}. Reference is made to Magic Angle Rotation (MAR).

In the case of this invention, the chemical shifts of the carbon atoms make it possible to characterize the organic groups. In particular, the carbon atoms that carry the terminal reactive groups of the material according to the invention have specific chemical shifts that are associated with the nature of these groups, thus making it possible to confirm their presence within the material according to the invention. In general, the spectrum that is obtained during the ¹³C NMR-MAR analysis of an organic group of a hybrid material is close to the spectrum that is obtained in the liquid phase for the corresponding organic precursor, whereby the signals are expanded based on the analysis of a solid matrix.

For example, the ¹³C NMR spectrum that is obtained for a mesostructured OIHM that consists of elementary spherical particles comprising a silicic matrix and organic groups with terminal reactive groups —R—F═—(CH₂)₂—C₆H₄—SO₃H that is obtained according to the first process for preparation according to the invention via the use of the cetyltrimethylammonium bromide quaternary ammonium salt CH₃(CH₂)₁₅N(CH₃)₃Br (CTAB) is characteristic of the liquid ¹³C NMR spectrum of the precursor (OMe)₃Si—(CH₂)₂—C₆H₄—SO₃H, whereby the signals are expanded.

When the desired terminal reactive group F is a sulfonic acid group, the characterization of the acidity that is expressed in terms of mmol of H⁺/g of inorganic material (also referred to as “proton exchange capacity”) is carried out by a metering via a base, whereby this base is generally NaOH soda.

The morphology and the size distribution of the elementary particles have been established by analysis of photos obtained by SEM.

### EXAMPLES

In the following examples, the aerosol technique that is used is the one that is described above in the disclosure of the invention.

### Example 1

### Preparation of a Mesostructured Organic-Inorganic Hybrid Material that Consists of a Silicic Matrix and Organic Groups —(CH₂)₂—C₆H₄—SO₃H with 10 mol % of the Inorganic Matrix that is Obtained According to the First Process for Preparation According to the Invention.

9 g of tetraethylorthosilicate (TEOS) and 3.20 g of 2-(4-chlorosulfonylphenyl-ethyl)trimethoxysilane (50 wt % in dichloromethane) are added to a solution that contains 65 g of ethanol, 34 g of water, 81 μl of HCl (35 wt %), and 3.08 g of surfactant CTAB.

The entire unit is left to stir at ambient temperature for 2 hours and 30 minutes until the precursors are completely dissolved. The entire mixture is sent into the chamber for atomization of the aerosol generator, and the solution is sprayed in the form of fine droplets under the action of vector gas (dry air) that is introduced under pressure (P=1 bar) as it was described in the description above.

The droplets are dried according to the operating procedure that is described in the disclosure of the invention above.

The temperature of the drying furnace is set at 350° C.

The recovered powder is then consolidated by running it through the oven at 130° C. for 60 hours. The CTAB surfactant is extracted from the hybrid material by reflux washing with absolute ethanol for 2 hours (100 ml of solvent/g of product).

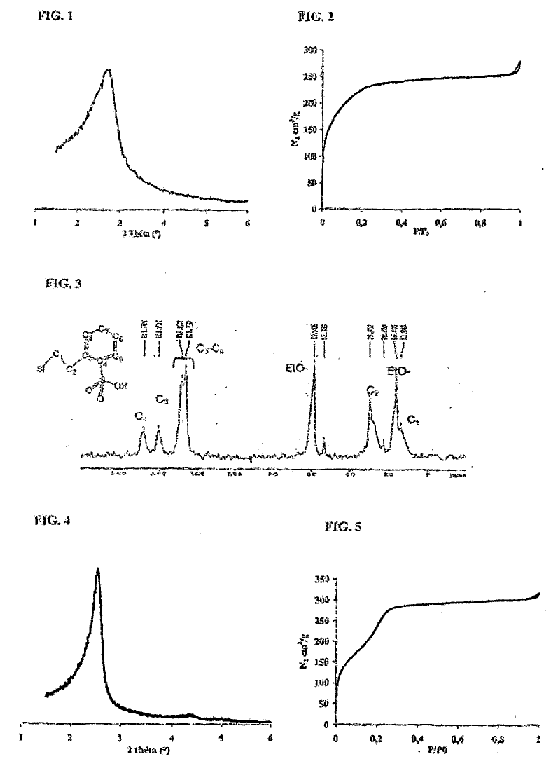

The solid is characterized by low-angle XRD (FIG. 1), by NitrogenVolumetric Analysis (FIG. 2, in which the value PO that is indicated on the abscissa is the saturating vapor pressure), by TEM, by ¹³C NMR-MAR (FIG. 3), by basic metering with soda, and by ICP.

The TEM analysis shows that the final hybrid material has an organized mesoporosity that is characterized by a 2D hexagonal structure.

The Nitrogen Volumetric Analysis leads to a specific surface area of the final hybrid material of S_{BET}=810 m²/g and to a mesoporous diameter of φ=2.1 nm.

The low-angle XRD analysis leads to the display of a correlation peak with the angle 2θ=2.6°. Bragg's equation 2 d*sin(1.3)=1.5406 makes it possible to calculate the distance d for correlation between the pores of the mesostructured matrix and therefore the mesh parameter a according to the equation a=2*d/\sqrt{3}|, or a=3.8 nm. The thickness of the walls of the mesostructured material that is defined by e=a−φ is therefore e=1.7 nm.

A SEM picture of the spherical elementary particles that are thus obtained indicates that these particles have a size that is characterized by a diameter that varies from 50 to 700 nm, whereby the size distribution of these particles is centered around 300 nm.

The association of each signal of the ¹³C NMR-MAR spectrum with a carbon atom of the functional group is shown in FIG. 3.

The experimental molar percentage of organic groups relative to the silicic matrix is 8.5% according to the ICP data.

The proton exchange capacity of the hybrid material according to the invention is estimated by metering with soda at 1.1 mmol of H⁺/g of SiO₂.

### Example 2

### Preparation of a Mesostructured Organic-Inorganic Hybrid Material that Consists of a Silicic Matrix and Organic Groups —(CH₂)₂—C₆H₄—SO₃H with 10 mol % of the Inorganic Matrix that is Obtained According to the Second Process for Preparation According to the Invention

9 g of tetraethylorthosilicate (TEOS) and 1.25 g of (2-phenylethyl)trimethoxy-silane are added to a solution that contains 65 g of ethanol, 34 g of water, 811 of HCT (35 wt %), and 3.08 g of CTAB surfactant.

The entire unit is left to stir at ambient temperature for 2 hours and 30 minutes until the precursors are completely dissolved. The entire mixture is sent into the atomization chamber of the aerosol generator, and the solution is sprayed in the form of fine droplets under the action of vector gas (dry air) that is introduced under pressure (P=1 bar) as it was described in the description above.

The droplets are dried according to the operating procedure that is described in the disclosure of the invention above.

The temperature of the drying furnace is set at 350° C.

The recovered powder is then consolidated by running it through the oven at 130° C. for 60 hours.

The CTAB surfactant is extracted from the hybrid material by reflux washing with absolute ethanol for 2 hours (100 ml of solvent/g of product).

The hybrid material that is thus obtained is then sulfonated by excess chlorosulfonic acid.

Typically, 380 mg of powder is placed in 8 ml of anhydrous chloroform in a container that was previously oven-dried and purged with argon, then 0.6 ml of HSO₃Cl is added.

The mixture is left to stir at ambient temperature for 30 minutes, then heated at 55° C. for 2 hours and 30 minutes. The mixture gradually takes on color, going from yellow to dark brown-black. The hydrolysis is carried out by 10 ml of 95% ethanol, then the product is washed with absolute ethanol, with distilled water until a neutral pH is reached, and then a last time with ethanol.

The hybrid material is then dried in the oven for one night at 60° C.

The solid is characterized by low-angle XRD, by NitrogenVolumetric Analysis, by TEM, by ¹³C NMR-MAR (FIG. 3), by basic metering with soda, and by ICP.

The TEM analysis shows that the final hybrid material has an organized mesoporosity that is characterized by a 2D hexagonal structure.

The Nitrogen Volumetric Analysis leads to a specific surface area of the final hybrid material of S_{BET}=890 m²/g and to a mesoporous diameter of φ=1.9 nm.

The low-angle XRD analysis leads to the display of a correlation peak with the angle 2θ=2.4°. Bragg's equation 2 d*sin (1.2)=1.5406 makes it possible to calculate the distance d for correlation between the pores of the mesostructured matrix and therefore the mesh parameter a according to the equation a=2*d/\sqrt{3}|, or a=4.2 nm. The thickness of the walls of the mesostructured material that is defined by e=a−φ is therefore e=2.3 nm.

A SEM picture of the spherical elementary particles that are thus obtained indicates that these particles have a size that is characterized by a diameter that varies from 50 to 700 nm, whereby the size distribution of these particles is centered around 300 nm.

The experimental molar percentage of sulfur-containing groups relative to the silicic matrix is 12% according to the ICP data.

The proton exchange capacity of the hybrid material according to the invention is estimated by metering with soda at 1.1 mmol of H⁺/g of SiO₂.

### Example 3

### Preparation of a Mesostructured Organic-Inorganic Hybrid Material that Consists of a Silicic Matrix and Organic Groups —(CH₂)₃—SO₃H with 10 mol % of the Inorganic Matrix that is Obtained According to the Second Process for Preparation According to the Invention.

9 g of tetraethylorthosilicate (TEOS) and 1.2 g of mercaptopropyltriethoxysilane are added to a solution that contains 65 g of ethanol, 34 g of water, 81 μl of HCl (35 wt %) and 3.08 g of CTAB surfactant.

The entire unit is left to stir at ambient temperature for 2 hours and 30 minutes until the precursors are completely dissolved. The entire mixture is sent into the atomization chamber of the aerosol generator, and the solution is sprayed in the form of fine droplets under the action of vector gas (dry air) that is introduced under pressure (P 1 bar) as it was described in the description above.

The droplets are dried according to the operating procedure that is described in the disclosure of the invention above.

The temperature of the drying furnace is set at 350° C.

The recovered powder is then consolidated by running it through the oven at 130° C. for 60 hours.

The CTAB surfactant is extracted from the hybrid material by reflux washing with absolute ethanol for 2 hours (100 ml of solvent/g of product).

The hybrid material that is thus obtained is then oxidized by nitric acid.

Typically, 1 g of powder is impregnated by nitric acid (HNO₃) that is diluted to 20 wt %, and then treated with 20 ml of HNO₃ at 68 wt % for 24 hours while being stirred. After oxidation, the powder is washed with water, acidified with 0.05 M sulfuric acid, then again washed copiously with water until a neutral pH is reached. After a last rinsing with ethanol, the hybrid material is dried in the oven for one night at 60° C.

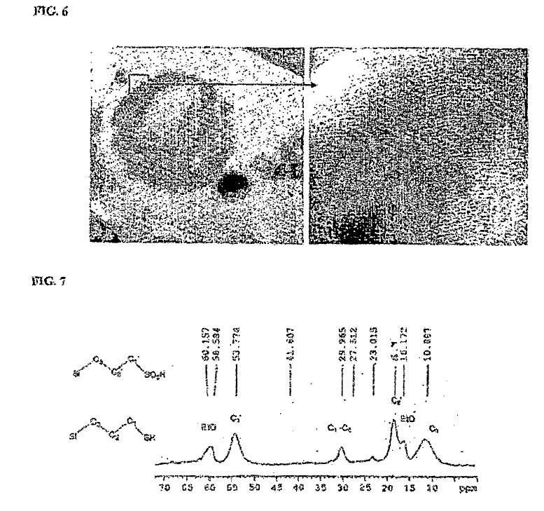

The solid is characterized by low-angle XRD (FIG. 4), by NitrogenVolumetric Analysis (FIG. 5 in which the value PO that is indicated on the abscissa is the saturating vapor pressure), by TEM (FIG. 6), by ¹³C NMR-MAR (FIG. 7), by basic metering with soda, and by ICP.

The TEM (Transmission Electron Microscopy) analysis shows that the final hybrid material has an organized mesoporosity that is characterized by a 2D hexagonal structure.

The Nitrogen Volumetric Analysis leads to a specific surface area of the final hybrid material of S_{BET}=800 m²/g and to a mesoporous diameter of φ=2.3 nm. The low-angle XRD analysis leads to the display of a correlation peak with the angle 2θ=2.5°. Bragg's equation 2 d*sin (1.3)=1.5406 makes it possible to calculate the distance d for correlation between the pores of the mesostructured matrix and therefore the mesh parameter a according to the equation a=2*d/\sqrt{3}|, or a=4.0 nm. The thickness of the walls of the mesostructured material that is defined by e=a−φ is therefore e=1.7 nm.

A SEM (Scanning Electronic Microscopy) picture of the spherical elementary particles that are thus obtained indicates that these particles have a size that is characterized by a diameter that varies from 50 to 700 nm, whereby the size distribution of these particles is centered around 300 nm.

The association of each signal of the ¹³C NMR-MAR spectrum with a carbon atom of the functional group is shown in FIG. 7.

The experimental molar percentage of organic groups relative to the silicic matrix is 10% according to the ICP data.

The proton exchange capacity of the hybrid material according to the invention is estimated by metering with soda at 1.4 mmol of H⁺/g of SiO₂.

### Example 4

### Preparation of a Mesostructured Organic-Inorganic Hybrid Material that Consists of a Silicic Matrix and Organic Groups —(CH₂)₃—SO₃H with 10 mol % of the Inorganic Matrix that is Obtained According to the Second Process for Preparation According to the Invention.

9 g of tetraethylorthosilicate (TEOS) and 1.2 g of mercaptopropyltriethoxysilane are added to a solution that contains 65 g of ethanol, 34 g of water, 81 μl of HCl (35 wt %) and 3.08 g of CTAB surfactant.

The entire unit is left to stir at ambient temperature for 2 hours and 30 minutes until the precursors are completely dissolved. The entire mixture is sent into the atomization chamber of the aerosol generator, and the solution is sprayed in the form of fine droplets under the action of vector gas (dry air) that is introduced under pressure (P 1 bar) as it was described in the description above.

The droplets are dried according to the operating procedure that is described in the disclosure of the invention above.

The temperature of the drying furnace is set at 350° C.

The recovered powder is then consolidated by running it through the oven at 130° C. for 60 hours.

The CTAB surfactant is extracted from the hybrid material by reflux washing with absolute ethanol for 2 hours (100 ml of solvent/g of product).

The hybrid material that is thus obtained is then oxidized by hydrogen peroxide.

Typically, 1 g of powder is treated with 37 ml of hydrogen peroxide (H₂O₂) at 30 wt % for 24 hours while being stirred. After oxidation, the powder is washed with water, acidified with 0.05 M sulfuric acid, then again washed copiously with water until a neutral pH is reached.

After a last rinsing with ethanol, the hybrid material is dried in the oven for one night at 60° C.

The solid is characterized by low-angle XRD, by NitrogenVolumetric Analysis, by TEM, by ¹³C NMR-MAR, by basic metering with soda, and by ICP.

The TEM analysis shows that the final hybrid material has an organized mesoporosity that is characterized by a 2D hexagonal structure.

The Nitrogen Volumetric Analysis leads to a specific surface area of the final hybrid material of S_{BET}=1010 m2/g and to a mesoporous diameter of φ=2.4 nm.

The low-angle XRD analysis leads to the display of a correlation peak with the angle 2θ=2.5°. Bragg's equation 2 d*sin (1.3)=1.5406 makes it possible to calculate the distance d for correlation between the pores of the mesostructured matrix and therefore the mesh parameter a according to the equation a=2*d/\sqrt{3}|, or a=4.0 nm. The thickness of the walls of the mesostructured material that is defined by e=a−φ is therefore e=1.6 nm.

A SEM picture of the spherical elementary particles that are thus obtained indicates that these particles have a size that is characterized by a diameter that varies from 50 to 700 nm, whereby the size distribution of these particles is centered around 300 nm.

The experimental molar percentage of organic groups relative to the silicic matrix is 7% according to the ICP data.

The proton exchange capacity of the hybrid material according to the invention is estimated by metering with soda at 1.3 mmol of H⁺/g of SiO₂.

### Example 5

### Preparation of a Mesostructured Organic-Inorganic Hybrid Material that Consists of a Silicic Matrix and Organic Groups —(CH₂)₃—SO₃H with 20 mol % of the Inorganic Matrix that is Obtained According to the Second Process for Preparation According to the Invention.

8 g of tetraethylorthosilicate (TEOS) and 2.4 g of mercaptopropyltriethoxysilane are added to a solution that contains 65 g of ethanol, 34 g of water, 811 of HCl (35 wt %), and 3.08 g of CTAB surfactant.

The entire unit is left to stir at ambient temperature for 2 hours and 30 minutes until the precursors are completely dissolved. The entire mixture is sent into the atomization chamber of the aerosol generator, and the solution is sprayed in the form of fine droplets under the action of vector gas (dry air) that is introduced under pressure (P=1 bar) as it was described in the description above. The droplets are dried according to the operating procedure that is described in the disclosure of the invention above.

The temperature of the drying furnace is set at 350° C.

The recovered powder is then consolidated by running it through the oven at 130° C. for 60 hours. The CTAB surfactant is extracted from the hybrid material by reflux washing with absolute ethanol for 2 hours (100 ml of solvent/g of product).

The hybrid material that is thus obtained is then oxidized by hydrogen peroxide.

Typically, 1 g of powder is treated with 37 ml of hydrogen peroxide (H₂O₂) at 30 wt % for 24 hours while being stirred. After oxidation, the powder is washed with water, acidified with 0.05 M sulfuric acid, then again washed copiously with water until a neutral pH is reached. After a last rinsing with ethanol, the hybrid material is dried in the oven for one night at 60° C.

The solid is characterized by low-angle XRD, by NitrogenVolumetric Analysis, by TEM, by ¹³C NMR-MAR, by basic metering with soda, and by ICP.

The TEM analysis shows that the final hybrid material has an organized mesoporosity that is characterized by a 2D hexagonal structure.

The Nitrogen Volumetric Analysis leads to a specific surface area of the final hybrid material of S_{BET}=565 m²/g and to a mesoporous diameter of φ=2.1 nm.

The low-angle XRD analysis leads to the display of a correlation peak with the angle 2θ=3.0°. Bragg's equation 2 d*sin (1.5)=1.5406 makes it possible to calculate the distance d for correlation between the pores of the mesostructured matrix and therefore the mesh parameter a according to the equation a=2*d/\sqrt{3}|, or a=3.5 nm. The thickness of the walls of the mesostructured material that is defined by e=a−φ is therefore e=1.4 nm.

A SEM picture of the spherical elementary particles that are thus obtained indicates that these particles have a size that is characterized by a diameter that varies from 50 to 700 nm, whereby the size distribution of these particles is centered around 300 nm.

The experimental molar percentage of organic groups relative to the silicic matrix is 19% according to the ICP data.

The proton exchange capacity of the hybrid material according to the invention is estimated by metering with soda at 2.0 mmol of H⁺/g of SiO₂.

### Example 6

### Preparation of a Mesostructured Organic-Inorganic Hybrid Material that Consists of a Silica-Zirconia Binary Matrix (90:10 mol) and Organic Groups —(CH₂)₃—SO₃H with 10 mol % of the Inorganic Matrix that is Obtained According to the Second Process for Preparation According to the Invention.

2.64 g of Pluronic copolymer P123 previously diluted in 30 g of ethanol, 1.85 g of zirconium chloride solution (ZrCl₄) in ethanol (1:5 mol) and 1.2 g of mercaptopropyl-triethoxysilane are mixed and then added to a solution that contains 8 g of tetraethylorthosilicate (TEOS), 24.3 g of ethanol, and 28.8 g of water.

The entire unit is left to stir at ambient temperature for 2 hours and 30 minutes until the precursors are completely dissolved. The entire mixture is sent into the atomization chamber of the aerosol generator, and the solution is sprayed in the form of fine droplets under the action of vector gas (dry air) that is introduced under pressure (P 1 bar) as it was described in the description above.

The droplets are dried according to the operating procedure that is described in the disclosure of the invention above.

The temperature of the drying furnace is set at 350° C.

The recovered powder is then consolidated by running it through the oven at 130° C. for 60 hours. The copolymer P123 is extracted from the hybrid material by Soxhlet reflux washing with absolute ethanol for 12 hours.

The hybrid material that is thus obtained is then oxidized by hydrogen peroxide.

Typically, 1 g of powder is treated with 37 ml of hydrogen peroxide (H₂O₂) at 30 wt % for 24 hours while being stirred. After oxidation, the powder is washed with water, acidified with 0.05 M sulfuric acid, then again washed copiously with water until a neutral pH is reached. After a last rinsing with ethanol, the hybrid material is dried in the oven for one night at 60° C.

The solid is characterized by low-angle XRD, by NitrogenVolumetric Analysis, by TEM, by ¹³C NMR-MAR, by basic metering with soda, and by ICP.

The TEM analysis shows that the final hybrid material has an organized mesoporosity that is characterized by a 2D hexagonal structure.

The Nitrogen Volumetric Analysis leads to a specific surface area of the final hybrid material of S_{BET}=580 m²/g and to a mesoporous diameter of φ=4.9 nm.

The low-angle XRD analysis leads to the display of a correlation peak with the angle 2θ=11.9°. Bragg's equation 2 d*sin (5.9)=1.5406 makes it possible to calculate the distance d for correlation between the pores of the mesostructured matrix and therefore the mesh parameter a according to the equation a=2*d/\sqrt{3}|, or a=8.6 nm. The thickness of the walls of the mesostructured material that is defined by e=a−φ is therefore e=3.7 nm.

A SEM picture of the spherical elementary particles that are thus obtained indicates that these particles have a size that is characterized by a diameter that varies from 50 to 700 nm, whereby the size distribution of these particles is centered around 300 nm.

The experimental molar percentage of organic groups relative to the silicic matrix is 8% according to the ICP data.

The proton exchange capacity of the hybrid material according to the invention is estimated by metering with soda at 1.2 mmol of H⁺/g of inorganic material.

### Example 7

### Preparation of a Mesostructured Organic-Inorganic Hybrid Material that Consists of a Silica-Zirconia Binary Matrix (85:15 mol) and Organic Groups —(CH₂)₃—NH₂ with 10 mol % of the Inorganic Matrix that is Obtained According to the First Process for Preparation According to the Invention.

2.64 g of Pluronic copolymer P123 previously diluted in 30 g of ethanol, 2.77 g of zirconium chloride solution (ZrCl₄) in ethanol (1:5 mol) and 0.9 g of aminopropyl-triethoxysilane are mixed and then added to a solution that contains 7.5 g of tetraethylorthosilicate (TEOS), 24.3 g of ethanol, 28.8 g of water, and 81 μl of HCl (35 wt %).

The entire unit is left to stir at ambient temperature for 2 hours and 30 minutes until the precursors are completely dissolved. The entire mixture is sent into the atomization chamber of the aerosol generator, and the solution is sprayed in the form of fine droplets under the action of vector gas (dry air) that is introduced under pressure (P=1 bar) as it was described in the description above.

The droplets are dried according to the operating procedure that is described in the disclosure of the invention above.

The temperature of the drying furnace is set at 350° C.

The recovered powder is then consolidated by running it through the oven at 130° C. for 60 hours. The copolymer P123 is extracted from the hybrid material by Soxhlet reflux washing with absolute ethanol for 12 hours and then dried in the oven for one night at 60° C.

The solid is characterized by low-angle XRD, by NitrogenVolumetric Analysis, by TEM, by ¹³C NMR-MAR, by basic metering with soda, and by ICP.

The TEM analysis shows that the final hybrid material has an organized mesoporosity that is characterized by a 2D hexagonal structure.

The Nitrogen Volumetric Analysis leads to a specific surface area of the final hybrid material of S_{BET}=460 m2/g and to a mesoporous diameter of φ=5.2 nm.

The low-angle XRD analysis leads to the display of a correlation peak with the angle 2θ=11.3°. Bragg's equation 2 d*sin (5.7)=1.5406 makes it possible to calculate the distance d for correlation between the pores of the mesostructured matrix and therefore the mesh parameter a according to the equation a=2*d/\sqrt{3}|, or a=9.1 nm. The thickness of the walls of the mesostructured material that is defined by e=a−φ is therefore e=3.9 nm.

A SEM picture of the spherical elementary particles that are thus obtained indicates that these particles have a size that is characterized by a diameter that varies from 50 to 700 nm, whereby the size distribution of these particles is centered around 300 nm.

The experimental molar percentage of organic groups relative to the silicic matrix is 8% according to the ICP data.

The quantity of amine groups of the hybrid material according to the invention is estimated by acid-basic metering at 1.4 mmol/g of inorganic material.

1. An organic-inorganic hybrid material (OIHM) in the form of spherical elementary particles, with a diameter of 50 nm to 10 microns, whereby each particle consists essentially of a mesostructured matrix based on silicon oxide, and organic groups with reactive terminal groups selected from among acid reactive groups, basic reactive groups, nucleophilic reactive groups, and adsorbent reactive groups, whereby said organic groups are linked covalently to the inorganic framework of the matrix, whereby said mesostructured matrix has a pore size of between 1.5 and 30 nm and has amorphous walls with a thickness of between 1 and 20 nm.

2. An organic-inorganic hybrid material according to claim 1, wherein the diameter of the spherical elementary particles varies from 50 nm to 300 nm.

3. An organic-inorganic hybrid material according to claim 1, wherein organic groups with a reactive terminal group are located on the walls of the pores of the mesostructured matrix.

4. An organic-inorganic hybrid material according to claim 1, wherein the organic groups have acidic reactive terminal groups selected among sulfonic acid —SO₃H, carboxylic acid —COOH and derivative, OH, phosphonic acid, or any combination thereof.

5. An organic-inorganic hybrid material according to claim 1, wherein the organic groups have basic reactive terminal groups selected among (primary, secondary, and tertiary), OH, or any combination thereof.

6. An organic-inorganic hybrid material according to claim 1, wherein the organic groups have nucleophilic reactive terminal groups.

7. An organic-inorganic hybrid material according to claim 1, wherein the organic groups have adsorbent terminal reactive groups.

8. An organic-inorganic hybrid material according to claim 1, wherein the organic groups of the mesostructured matrix are identical.

9. An organic-inorganic hybrid material according to claim 1, wherein the organic groups of the mesostructured matrix are different.

10. An organic-inorganic hybrid material according to claim 1, wherein the organic groups represent 0.1 to 50 mol %, of the matrix based on silicon oxide.

11. An organic-inorganic hybrid material according to claim 1, wherein the matrix based on silicon oxide also contains at least one element Z selected from the group that consists of aluminum, titanium, tungsten, zirconium and cerium.

12. An organic-inorganic hybrid material according to claim 1, having a specific surface area between 100 and 1500 m²/g.

13. A method for the production of organic-inorganic hybrid material according to claim 1, comprising the following serial stages:
a) mixing in solution of at least one surfactant, at least one silicic precursor, optionally at least one precursor of at least one element Z that is selected from the group that consists of aluminum, titanium, tungsten, zirconium and cerium, and at least one organosilane precursor having at least one terminal reactive group,
b) conducting atomization to form an aerosol of said solution that is obtained in stage a) so as to produce spherical droplets with a diameter of less than 200 μm,
c) drying said droplets, and
d) eliminating said surfactant.

14. A method for the production of organic-inorganic hybrid material according to claim 1, comprising the following serial stages:
a′) mixing in solution of at least one surfactant, at least one silicic precursor, optionally at least one precursor of at least one element Z that is selected from the group that consists of aluminum, titanium, tungsten, zirconium and cerium, and at least one organosilane precursor having at least one intermediate organic group with an organic group having a desired terminal reactive group for the final material,
b′) atomization to form an aerosol of said solution that is obtained in stage a′) so as to produce spherical droplets with a diameter of less than 200 μm,
c′) drying said droplets,
d′) elimination of said surfactant so as to obtain a material with organized and uniform porosity, and
e′) transformation of the intermediate organic group of the hybrid material that is obtained in stage d′) into the organic group having the terminal reactive group that is desired by suitable chemical treatments.

15. A process according to claim 13, conducted continuously.

16. An organic-inorganic hybrid material according to claim 1, wherein the reactive terminal groups comprise sulfuric acid.

17. An organic-inorganic hybrid material according to claim 1, wherein the reactive terminal groups comprises halides.

18. An organic-inorganic hybrid material according to claim 1, wherein the reactive terminal groups comprises chlorine.

19. An organic-inorganic hybrid material according to claim 1, wherein the reactive terminal groups comprises thiols.

20. An organic-inorganic hybrid material according to claim 1, wherein the reactive terminal groups comprises —SM.

21. An organic-inorganic hybrid material according to claim 1, wherein the organic groups represent 0.1-30 mol % of the matrix based on silicon oxide.

22. An organic-inorganic hybrid material according to claim 12, wherein the specific surface area is 300-1000 m²/g.
